(19) United States
(12) Patent Application Publication
(10) Pub. No.: US 2017/0084405 A1
(43) Pub. Date: Mar. 23, 2017

(54) Switch of Nonmetallic Macromolecular Conductive Material being Water-resistant and resistant to Oxidation and process of Manufacturing Same

(71) Applicant: Szu-Wei Sun, Taoyuan City (TW)

(72) Inventor: Szu-Wei Sun, Taoyuan City (TW)

(21) Appl. No.: 14/858,765

(22) Filed: Sep. 18, 2015

(51) Int. Cl. H01H 13/14; H01H 13/06; H01H 13/88

(52) U.S. Cl. CPC H01H 13/14; H01H 13/88; H01H 13/06

(57) ABSTRACT

A switch of nonmetallic macromolecular conductive material being water-resistant and resistant to oxidation includes a circuit board having electronic circuitry and a plurality of electrical contact assemblies on a top surface; and a plurality of elastic members mounted on the circuit board and each including a bottom opening, and a stem on a bottom of a top extending downward toward the bottom opening. Each electrical contact assembly is surrounded by the elastic member and the circuit board. An electrically conductive member made of nonmetallic macromolecular conductive material is formed on a bottom of the stem. An electrical contact made of nonmetallic macromolecular conductive material is formed on each electrical contact assembly. A process of manufacturing same is also included.

### BACKGROUND OF THE INVENTION

1. Field of the Invention

The invention relates to switches and more particularly to a switch made of nonmetallic macromolecular conductive material being water-resistant and resistant to oxidation and a process of manufacturing same, silver conductive paste being coated on an electrically conductive member and electrical contact(s) respectively so that the problem of oxidized silver conductive paste member can be solved.

2. Description of Related Art

A conventional switch of a keyboard comprises a circuit board, a membrane switch, and a flexible actuator including a dome-shaped elastic member and a stem extending downward from a bottom of a top of the elastic member toward a bottom opening. The actuator is mounted on the circuit board. Circuitry is embedded on the membrane switch by coating silver conductive paste thereon. The electrically conductive member on the bottom of the stem can contact the electrical contact on the circuit board to close a circuit and create a signal representing a depressing of a key after sufficiently depressing the elastic member.

A carbon member is formed to conceal the electrically conductive member. However, the carbon member may be worn after a period time of use. As such, resistance is increased greatly and contact is poor. Further, the silver conductive paste member is oxidized due to exposure to air.

For solving above problems, another conventional switch is provided and is characterized by replacing the carbon member with a silver conductive paste member for the purpose of decreasing wear. However, the silver conductive paste member can be quickly oxidized after exposure to water or moisture. The oxidized silver conductive paste member can make contact poor.

Navy has implemented a method of concealing a keyboard incorporating the switches when maneuvering on the sea for the sake of preventing the switches from contacting water. Otherwise, the switches may be quickly oxidized. However, the keyboard is made bulky and thus is not easy to carry. Thus, the need for improvement still exists.

### SUMMARY OF THE INVENTION

It is therefore one object of the invention to provide a process of manufacturing a switch being water-resistant and resistant to oxidation, comprising the steps of preparing a nonmetallic macromolecular conductive material; mixing the nonmetallic macromolecular conductive material with a thickening agent to form a gelled mixture; and coating the gelled mixture on an electrically conductive member and an electrical contact of a switch respectively.

Another object of the invention is to provide a switch made of nonmetallic macromolecular conductive material, comprising a circuit board having electronic circuitry and a plurality of electrical contact assemblies on a top surface; and a plurality of elastic members mounted on the circuit board and each including a bottom opening, and a stem on a bottom of a top extending downward toward the bottom opening; wherein each electrical contact assembly is surrounded by the elastic member and the circuit board; an electrically conductive member made of nonmetallic macromolecular conductive material is formed on a bottom of the stem; and an electrical contact made of nonmetallic macromolecular conductive material is formed on each electrical contact assembly.

The above and other objects, features and advantages of the invention will become apparent from the following detailed description taken with the accompanying drawings.

### BRIEF DESCRIPTION OF THE DRAWINGS

FIG. 1 is a flow chart illustrating a process of manufacturing a switch made of nonmetallic macromolecular conductive material being water-resistant and resistant to oxidation;

FIG. 2 is a perspective view of an elastic member of the invention;

FIG. 3A is a longitudinal sectional view of the elastic member mounted on a circuit board according to a first preferred embodiment of the invention;

FIG. 3B is a view similar to FIG. 3A showing the depressed elastic member and the electrically conductive member contacting the electrical contacts;

FIG. 4A is a longitudinal sectional view of the elastic member mounted on a circuit board according to a second preferred embodiment of the invention;

FIG. 4B is a view similar to FIG. 4A showing the depressed elastic member and the electrically conductive member contacting the electrical contacts;

FIG. 5A is a longitudinal sectional view of the elastic member mounted on a circuit board according to a third preferred embodiment of the invention;

FIG. 5B is a view similar to FIG. 5A showing the depressed elastic member and the electrically conductive member contacting the electrical contacts;

FIG. 6 is a longitudinal sectional view showing three elastic members mounted on the circuit board.

### DETAILED DESCRIPTION OF THE INVENTION

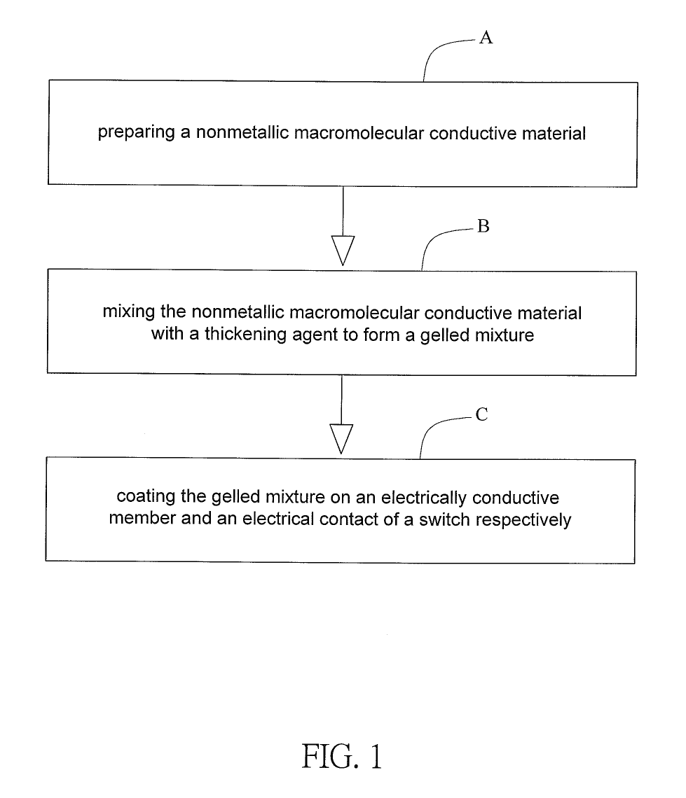

Referring to FIG. 1, a process of manufacturing a switch made of nonmetallic macromolecular conductive material being water-resistant and resistant to oxidation in accordance with the invention is illustrated. The process comprises steps A of preparing a nonmetallic macromolecular conductive material made of Graphene, liquid Ethylenedioxythiophene, or polyaniline in which either Graphene or polyaniline is grinded to nano-scale powder; step B of mixing one of Graphene, liquid Ethylenedioxythiophene, and polyaniline, or a combination thereof with a thickening agent to form a gelled mixture; and step C of coating the gelled mixture on an electrically conductive member and an electrical contact of the switch respectively.

The invention can eliminate conventional problems of increased resistance and poor contact of the switch due to oxidation.

Preferably, the nonmetallic macromolecular conductive material of the gelled mixture is 1% to 50% by weight of the gelled mixture.

Preferably, the thickening agent of the gelled mixture is 50% to 99% by weight of the gelled mixture.

Preferably, the thickening agent of the gelled mixture is glue or resin.

Preferably, the electrically conductive member is coated with silver conductive paste prior to coating the gelled mixture.

Preferably, the electrical contact is coated with silver conductive paste prior to coating the gelled mixture.

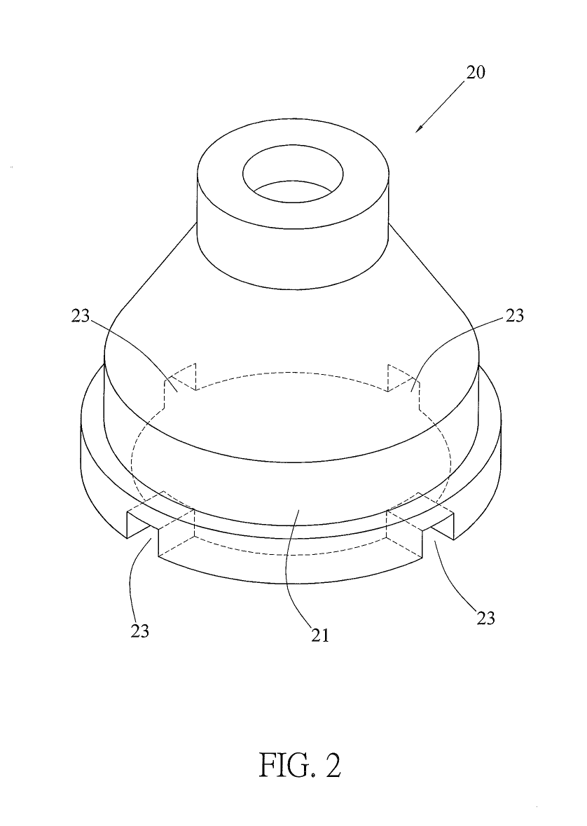

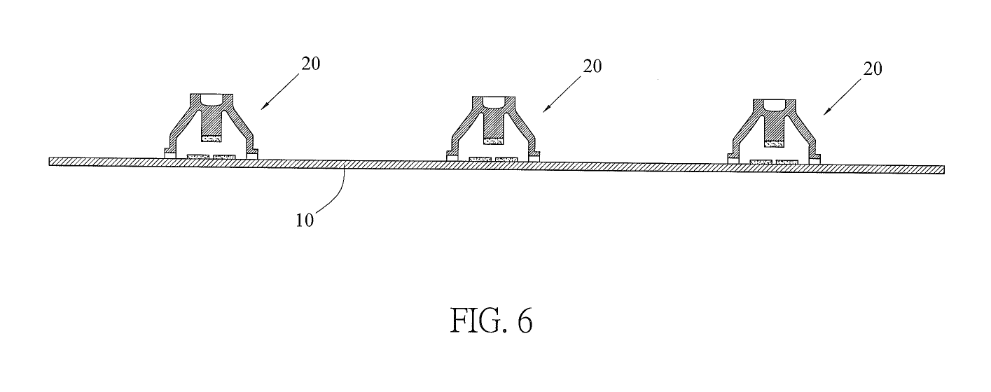

Referring to FIGS. 2 to 6, a switch made of nonmetallic macromolecular conductive material in accordance with the invention comprises a circuit board 10 having electronic circuitry and a plurality of electrical contact assemblies 11 on a top surface; and a plurality of elastic members 20 mounted on the circuit board 10 and each including a bottom opening 21, a stem 22 downward extending toward the bottom opening 21, and a plurality of through holes 23 on the bottom. The electrical contact assembly 11 is surrounded by the elastic member 20 and the circuit board 10.

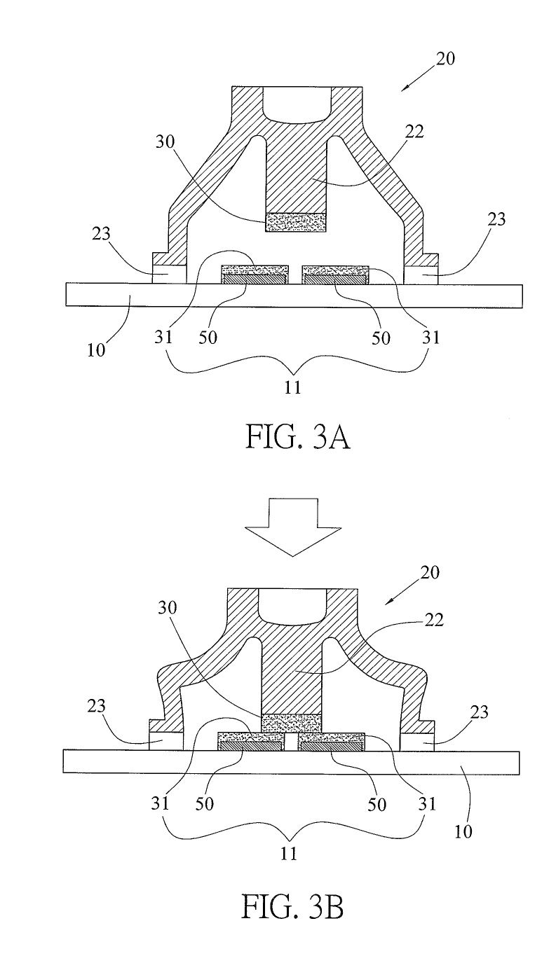

In FIGS. 3A and 3B, a first preferred embodiment of the invention is shown. An electrically conductive member 30 made of nonmetallic macromolecular conductive material is formed on a bottom of the stem 22. Two first silver conductive paste members 50 are formed on the circuit board 10 within the elastic member 20. An electrical contact 31 made of nonmetallic macromolecular conductive material is formed on each first silver conductive paste member 50 to conceal it. The electrically conductive member 30 can contact the electrical contacts 31 to close a circuit and create a signal representing a depressing of a key after sufficiently depressing the elastic member 20.

Preferably, the electrically conductive member 30 is made of one of Graphene, liquid Ethylenedioxythiophene, and polyaniline, or a combination thereof.

Preferably, the electrical contact 31 is made of one of Graphene, liquid Ethylenedioxythiophene, and polyaniline, or a combination thereof.

Preferably, the first silver conductive paste members 50 are formed prior to coating silver conductive paste on the first silver conductive paste members 50 to form the electrical contacts 31.

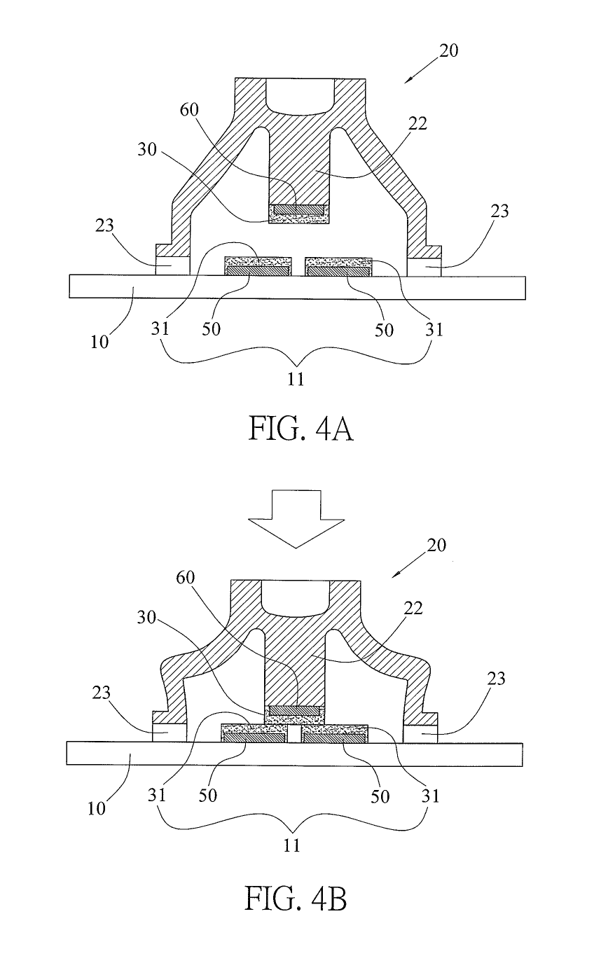

In FIGS. 4A and 4B, a second preferred embodiment of the invention is shown. A second silver conductive paste member 60 is formed on a bottom of the stem 22 by coating silver conductive paste thereon. An electrically conductive member 30 made of nonmetallic macromolecular conductive material is formed on the bottom of the stem 22 with the second silver conductive paste member 60 concealed therein. Two first silver conductive paste members 50 are formed on the circuit board 10 within the elastic member 20. An electrical contact 31 is formed on each first silver conductive paste member 50 to conceal it. The electrically conductive member 30 can contact the electrical contacts 31 to close a circuit and create a signal representing a depressing of a key after sufficiently depressing the elastic member 20.

Preferably, the electrically conductive member 30 is made of one of Graphene, liquid Ethylenedioxythiophene, and polyaniline, or a combination thereof.

Preferably, the electrical contact 31 is made of one of Graphene, liquid Ethylenedioxythiophene, and polyaniline, or a combination thereof.

Preferably, the first silver conductive paste members 50 are formed prior to coating silver conductive paste on the first silver conductive paste members 50 to form the electrical contacts 31.

Preferably, the second silver conductive paste member 60 is formed prior to coating silver conductive paste on the second silver conductive paste member 60 to form the electrically conductive member 30.

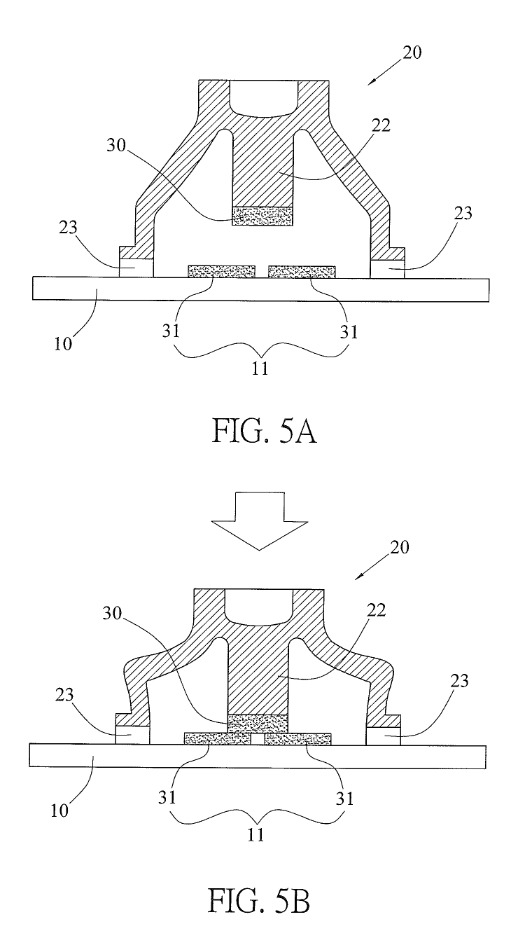

In FIGS. 5A and 5B, a third preferred embodiment of the invention is shown. An electrically conductive member 30 made of nonmetallic macromolecular conductive material is formed on the bottom of the stem 22. Two electrical contacts 31 are formed on the circuit board 10 within the elastic member 20. The electrically conductive member 30 can contact the electrical contacts 31 to close a circuit and create a signal representing a depressing of a key after sufficiently depressing the elastic member 20.

Preferably, the electrically conductive member 30 is made of one of Graphene, liquid Ethylenedioxythiophene, and polyaniline, or a combination thereof.

Preferably, the electrical contact 31 is made of one of Graphene, liquid Ethylenedioxythiophene, and polyaniline, or a combination thereof.

It is envisaged by the invention that the provision of the electrically conductive member 30 and the electrical contacts 31 can greatly decrease wear due to increased number of key depressing. Further, the conventional problems of increased resistance and poor contact of the switch due to oxidation are eliminated. Furthermore, the conventional problems of oxidization of the first and second silver conductive paste members 50, 60 due to moisture, and poor contact of the first and second silver conductive paste members 50, 60 are eliminated. As a result, the switch is more durable and is adapted to mount on an underwater device or operate in a humid environment.

Resistance of a wire of silver conductive paste prior to oxidation is measured and resistance of the wire of silver conductive paste after the oxidation is measured respectively. First, a wire of silver conductive paste is prepared and a resistance of the wire of silver conductive paste is measured. The value is 4.5 Ω (Ohm). Next, the wire of silver conductive paste is placed in a water tank to be oxidized for ten days. After ten days, the wire of silver conductive paste is removed out of the water tank. Next, a resistance of the oxidized wire of silver conductive paste is measured. The value is 13.1 Ω (Ohm). It is found that the resistance of the wire of silver conductive paste is increased greatly.

The oxidized wire of silver conductive paste of above paragraph is coated with Graphene prior to being placed in an oven. The wire of silver conductive paste is heated at 130° C. for 30 minutes in the oven. Thereafter, a resistance of the dried wire of silver conductive paste coated with Graphene is measured. The value is 8.3 Ω (Ohm). Next, the wire of silver conductive paste is placed in a water tank to be oxidized for ten days. After ten days, the wire of silver conductive paste is removed out of the water tank. Next, a resistance of the wire of silver conductive paste is measured. The value is 9.3 Ω (Ohm). It is found that the resistance of the wire of silver conductive paste does not increase significantly.

It is concluded that a wire of silver conductive paste coated with Graphene of the invention can completely eliminate the conventional problem of oxidization of silver conductive paste member. Further, no significant increase of resistance of the wire of silver conductive paste is measured. Furthermore, the conventional problem of poor contact is completely eliminated.

While the invention has been described in terms of preferred embodiments, those skilled in the art will recognize that the invention can be practiced with modifications within the spirit and scope of the appended claims.

What is claimed is:

1. A process of manufacturing a switch being water-resistant and resistant to oxidation, comprising the steps of:
preparing a nonmetallic macromolecular conductive material;
mixing the nonmetallic macromolecular conductive material with a thickening agent to form a gelled mixture; and
coating the gelled mixture on an electrically conductive member and an electrical contact of a switch respectively.

2. The process of claim 1, wherein the nonmetallic macromolecular conductive material is made of one of Graphene, liquid Ethylenedioxythiophene, and polyaniline, or a combination thereof.

3. The process of claim 2, wherein either Graphene or polyaniline is grinded to nano-scale powder.

4. The process of claim 1, wherein the nonmetallic macromolecular conductive material of the gelled mixture is 1% to 50% by weight of the gelled mixture.

5. The process of claim 1, wherein the thickening agent of the gelled mixture is 50% to 99% by weight of the gelled mixture.

6. The process of claim 1, wherein the thickening agent of the gelled mixture is either glue or resin.

7. The process of claim 1, wherein the electrically conductive member is coated with silver conductive paste prior to coating the gelled mixture.

8. The process of claim 1, wherein the electrical contact is coated with silver conductive paste prior to coating the gelled mixture.

9. A switch made of nonmetallic macromolecular conductive material, comprising:
a circuit board having electronic circuitry and a plurality of electrical contact assemblies on a top surface; and
a plurality of elastic members mounted on the circuit board and each including a bottom opening, and a stem on a bottom of a top extending downward toward the bottom opening;
wherein each electrical contact assembly is surrounded by the elastic member and the circuit board; an electrically conductive member made of nonmetallic macromolecular conductive material is formed on a bottom of the stem; and an electrical contact made of nonmetallic macromolecular conductive material is formed on each electrical contact assembly.

10. The switch of claim 9, wherein the electrically conductive member is made of one of Graphene, liquid Ethylenedioxythiophene, and polyaniline, or a combination thereof.

11. The switch of claim 9, wherein the electrical contact is made of one of Graphene, liquid Ethylenedioxythiophene, and polyaniline, or a combination thereof.

12. The switch of claim 9, wherein a silver conductive paste member is formed on the bottom of the stem prior to forming the electrically conductive member.

13. The switch of claim 9, wherein a silver conductive paste element is formed on each electrical contact assembly prior to forming the electrical contact.
